(19) United States
(12) Patent Application Publication
(10) Pub. No.: US 2017/0255280 A1
(43) Pub. Date: Sep. 7, 2017

(54) SmartKnob

(71) Applicant: Methode Electronics, Inc., Carthage, IL (US)

(72) Inventors: Ernest Pacsai, Wixom, MI (US); Tim Green, Holly, MI (US); Richard P. Jasinski, Highland, MI (US)

(21) Appl. No.: 15/449,604

(22) Filed: Mar. 3, 2017

Related U.S. Application Data
(60) Provisional application No. 62/303,073, filed on Mar. 3, 2016.

(51) Int. Cl. G06F 3/0362; H01H 19/02; B60K 37/06; H01H 19/14

(52) U.S. Cl. CPC G06F 3/0362; H01H 19/14; H01H 19/025; B60K 37/06; H01H 2219/0026; H01H 2219/039; H01H 2215/00; H01H 2231/026; B60K 2350/102; B60K 2350/106; B60K 2350/1096

(57) ABSTRACT

A rotary control knob for an automobile has a central portion comprising a display and a radial encoder disposed therearound. The display selectively displays first information regarding a first function of the automobile and second information regarding a second function of the automobile. The radial encoder selectively receives input regarding the first and the second functions. The radial encoder can selectively receive input regarding the first function only when the first information is displayed on the display, and receive input regarding the second function only when the second information is displayed on the display. Or, the radial encoder can selectively receive input regarding the first function only when the first information is displayed in a primary area of the display, while displaying the second information in a secondary area. Capacitive coupling can identify user seat location to provide driver and front passenger specific zone features.

### RELATED APPLICATION

This application claims benefit of priority of U.S. Provisional Application No. 62/303,073, filed Mar. 3, 2016, entitled “SmartKnob for a Vehicle.” The above-identified related application is incorporated herein by reference.

### FIELD OF THE INVENTION

The present invention relates to a knob configured for displaying information regarding various features in an automobile and controlling various function in an automobile.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1A illustrates a rotary knob, in accordance with an exemplary embodiment of the present invention;

FIG. 1B illustrates another rotary knob, in accordance with an exemplary embodiment of the present invention;

FIG. 2 illustrates a centerstack of an automobile incorporating a least one of the knobs of FIG. 1A or FIG. 1B, in accordance with an exemplary embodiment of the present invention;

FIGS. 3A and 3B illustrate exemplary information that may be displayed on the knobs of FIG. 1A or FIG. 1B, in accordance with an exemplary embodiment of the present invention;

FIGS. 4 and 5 illustrate user touch, or human interface, for controlling the rotary knob, in accordance with an exemplary embodiment of the present invention;

FIG. 6 illustrates capacitive coupling as an interface for controlling the rotary knob, in accordance with an exemplary embodiment of the present invention;

FIG. 7 illustrates an IR sensor or camera as an interface for controlling the rotary knob, in accordance with an exemplary embodiment of the present invention; and

FIG. 8 illustrates a fingerprint sensor as an interface for controlling the rotary knob, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

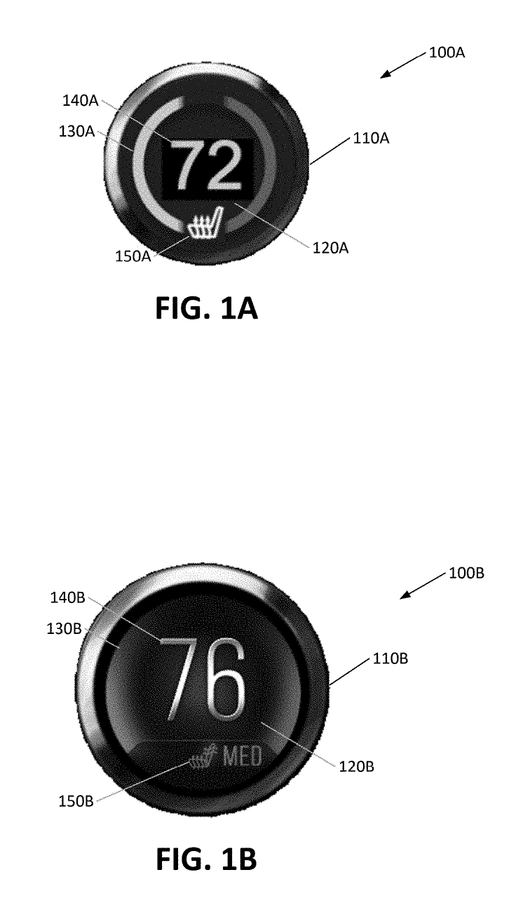

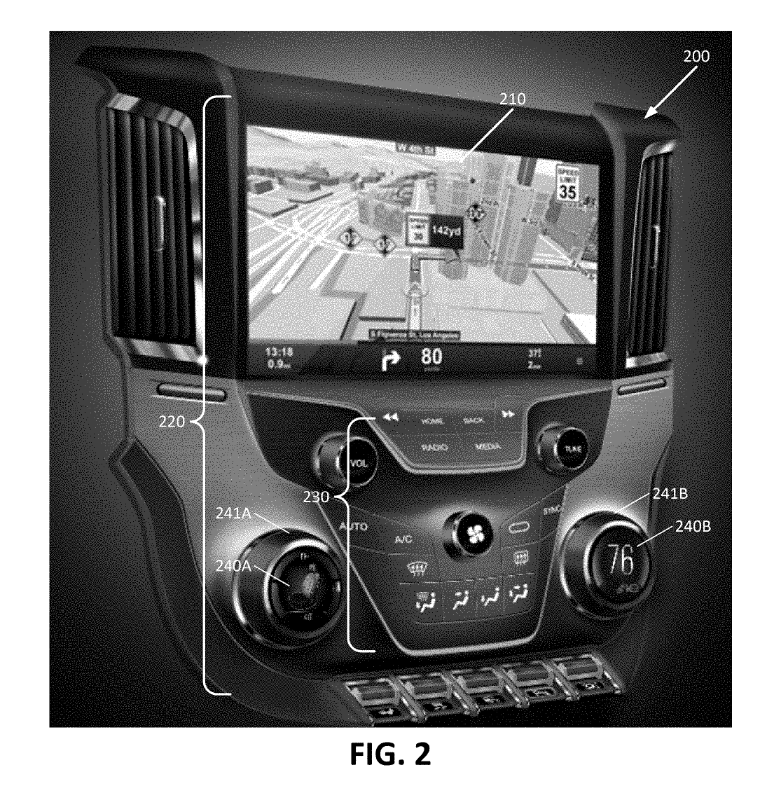

Referring now to FIG. 1A, there is illustrated exemplary embodiment of a rotary knob 100A, also referred to as a “SmartKnob,” in accordance with an exemplary embodiment of the present invention. The knob 100A comprises an outer ring 110A and a display 120A in its center. The outer ring 110A include a rotary encoder for determining a rotational position of the ring 110A. The display 120A is a high resolution graphic display and may be a TFT LCD or OLED display. The display 120A displays information 140A regarding a feature or system of an automotive, and can be referred to as a primary display. The display 120A further displays segments 130A corresponding to a range of selections that a user may make via the knob 100A.

Referring now to FIG. 1B, there is illustrated another exemplary embodiment of a rotary knob 100B, in accordance with an exemplary embodiment of the present invention. The knob 100B comprises an outer ring 110B and a display 120B in its center (also referred to as a primary display). The outer ring 110B include a rotary encoder for determining a rotational position of the ring 110B. The display 120B is a high resolution graphic display and may be a TFT LCD or OLED display. The knob 100B differs from the knob 100A in that the display 120B has a higher resolution that the display 120A. The display 120B displays information 140B regarding a feature or system of an automotive. The display 120B further displays segments 130B corresponding to a range of selections that a user may make via the knob 100B.

The knobs 100A and 100B are configured for use in an automobile for controlling systems or features of the automobile and displaying data regarding systems or features of the automobile. The outer ring 110A, 110B allows a user to change a setting for a system or feature of the automobile. The display 120A, 120B displays data regarding one or more systems or features of the automobile.

In the exemplary embodiments illustrated in FIGS. 1A and 1B, the knobs 100A and 100B are displaying data regarding a temperature setting of a heating, ventilation, and air conditioning (HVAC) system of the automobile. In the embodiments shown, the displays 120A, 120B (primary displays) comprise respective indications 140A, 140B of a temperature set point of the HVAC system. They also comprise respective indication 150A, 150B, also referred to as secondary displays, which could indicate whether a heated seat is activated. The indication 150B may also provide information whether the heated seat is on low, medium, or high (i.e., the heated seat setting). Finally, the displays 120A, 120B further comprises respective indications 130A, 130B of temperature gradients that graphically illustrate a range of temperatures over which the temperature setpoint may be selected.

Although the exemplary embodiments illustrated in FIGS. 1A and 1B pertain to HVAC information and HVAC control, it is to be understood that the knobs 100A, 100B may display information related to an automobile's transmission (e.g., P, R, N, D) or audio system, and may display warning indicators (in primary or secondary displays). Displaying other information involves displaying other information in the displays 120A, 120B. It is understood that embodiments of the present invention may include a single display on the knob 100A, 100B, or multiple displays on the knob 100A, 100B (primary display, secondary display, etc.).

It is also contemplated that the displays 120A, 120B may display video or other animations and may also display user-specific data from the cloud. Thus, the knobs 100A, 100B may be web-connected.

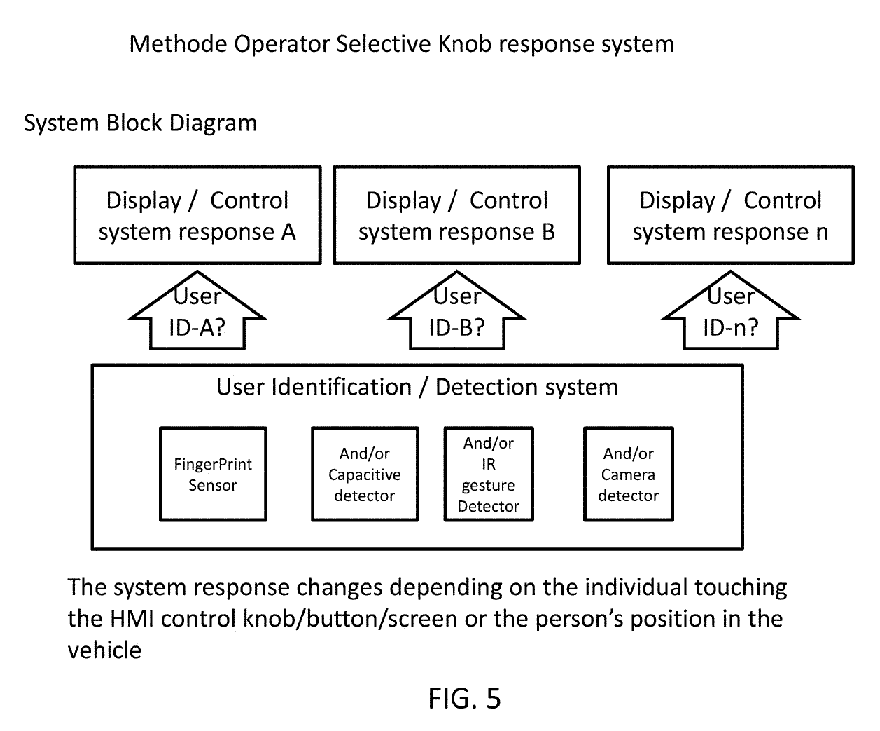

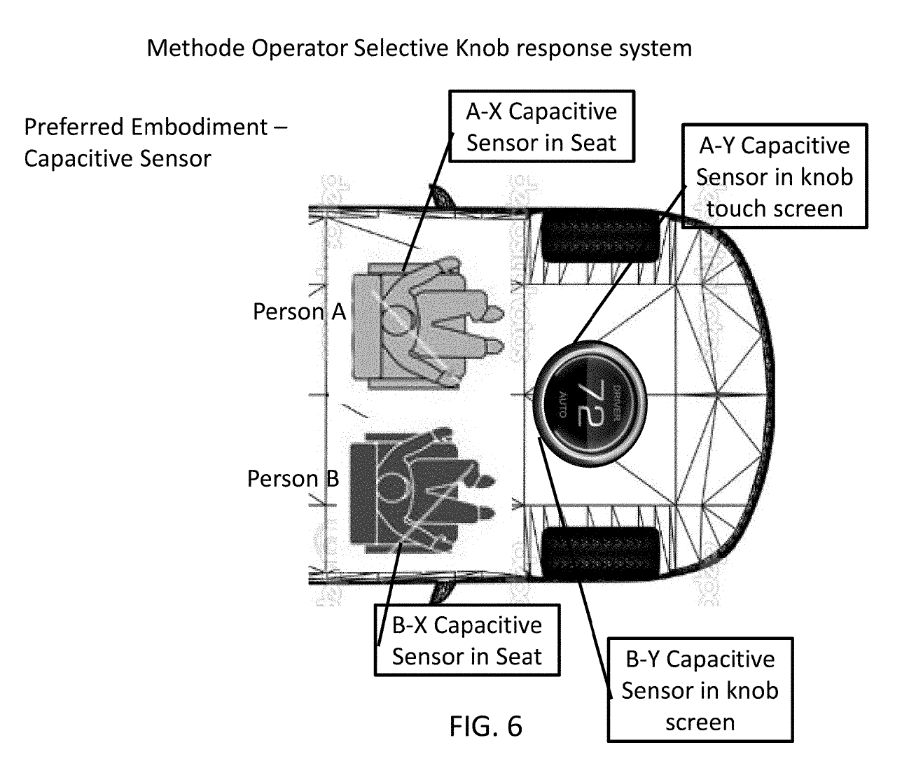

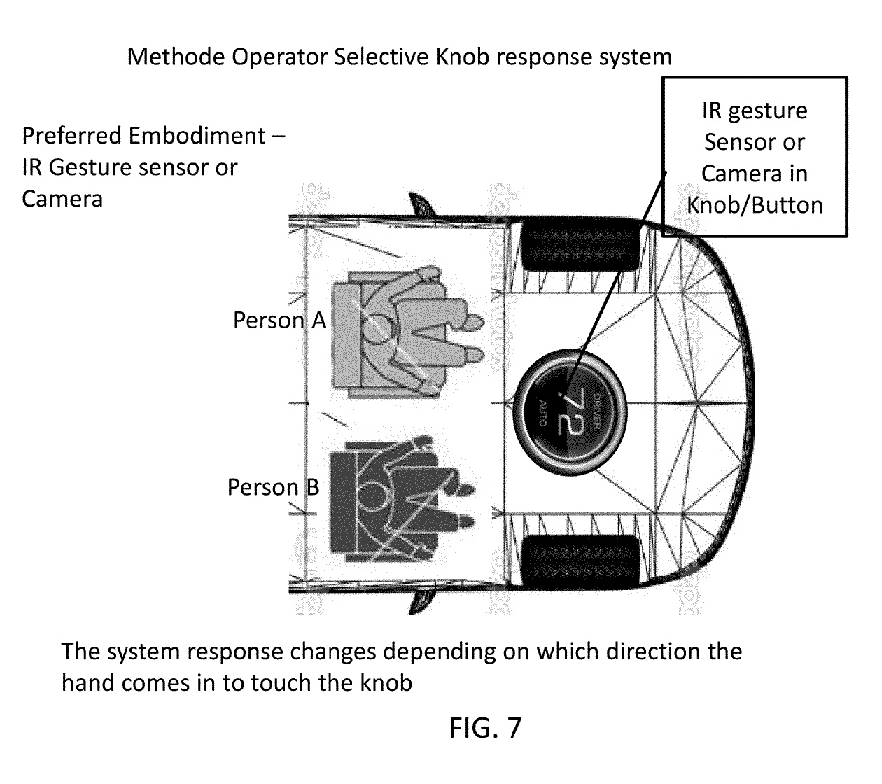

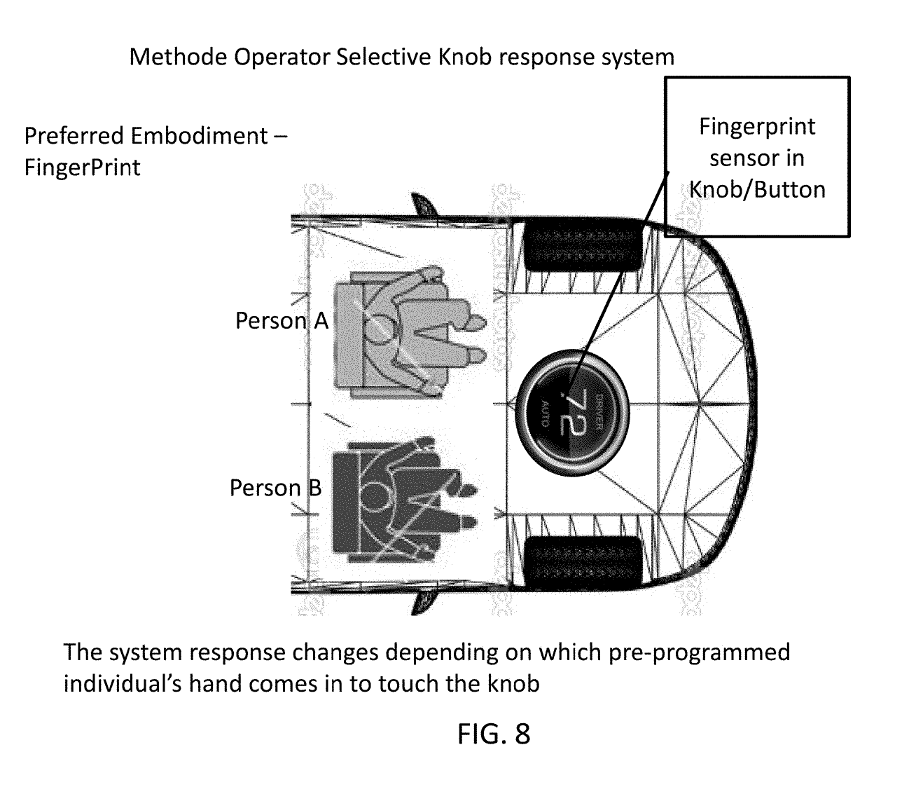

In addition to being operated via the ring 110A, 110B around its perimeter, the knob 100A, 100B may, in some instances, be operated via: a touch-sensitive feature in the display 120A, 120B; push, pull, and joystick-type movements of the knob 100A, 100B; voice recognition; gesture/proximity recognition; and/or biometric (e.g., fingerprint, facial) recognition. Each knob 100A, 100B may include a microphone for voice sensing, as well as an IR sensor for non-contact gesture sensing. Each knob 100A, 100B may include an integrated camera and, in the case of two or more knobs 100A, 100B, 3D sensing may be performed. The above-identified instances of operation could be used as an alternative to the ring 110A, 110B, or could be used to change the function selected and displayed (that the ring 110A, 110B operates). The system that incorporates the knob 100A, 100B may identify drivers or passengers based on capacitive coupling from vehicle seat locations. Finally, the knob 100A, 100B may provide haptic feedback, audio output (e.g., voice, chimes, tones), and halo or ring lighting. Various instances of operation, as identified above, are illustrated in FIGS. 4-8.

In an exemplary embodiment, the data displayed on the display 120A, 120B of the knob 100A, 100B may change as the knob 100A, 100B is depressed, operated, spoken-to, etc. The knob 100A, 100B may first display a temperature setpoint of an HVAC control. After being depressed, the knob 100A, 100B may display information regarding a heated seat setting. In another embodiment, the radial encoder selectively receives input via the ring 110A, 110B regarding a first function (e.g., a temperature setpoint of an HVAC control) only when the first information (e.g., temperature setpoint) is displayed in a primary area of the display 120A, 120B of the knob 100A, 100B, while displaying second information (e.g., indication whether a heated seat is activated and/or setpoint) in a secondary area of the display 150A, 150B, and receives input via the ring 110A, 110B regarding a second function (e.g., heated seat) only when the second information is displayed in the primary area of the display 120, 120B, while displaying the first information (e.g., HVAC temperature setpoint) in a secondary area of the display 150A, 150B.

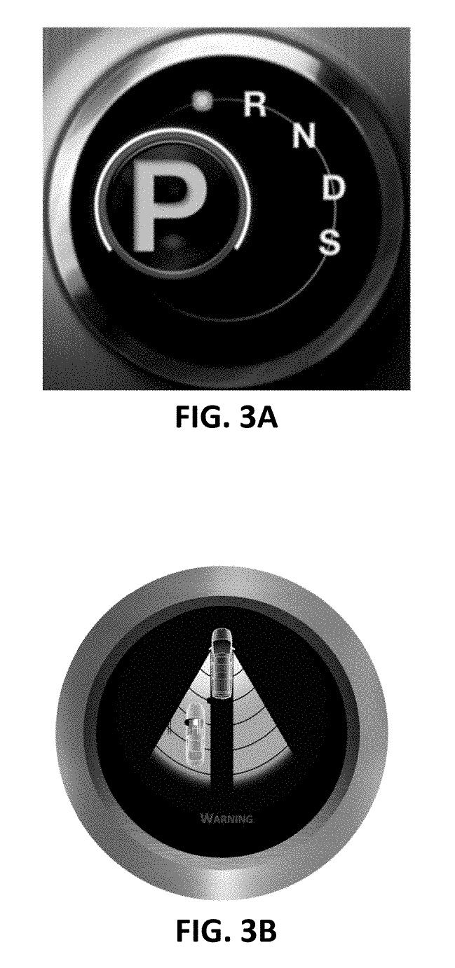

Referring now to FIG. 2, there is illustrated an interior of an automobile 200, in accordance with an exemplary embodiment of the present invention. The automobile 200 comprises a display 210 and a plurality of controls 230 in a center-stack 220 of the automobile 200. The controls 230 are conventional buttons and knobs for controlling various features of the automobile 200. Disposed on either side of the controls 230 are knobs 240A and 240B, which may be either of the knobs 100A, 100B.

As illustrated in FIG. 2, the knob 240A is currently displaying information regarding a heated seat setting. The knob 240A may be used to change the heated seat setting through manipulation of its outer ring 241A. The knob 240B is currently displaying information regarding an HVAC set point. The knob 240B may be used to change the HVAC set point through manipulation of its outer ring 241B.

Which automobile system or feature each knob 240A, 240B displays information from and is currently accepting input to control may be changed through depression of the knob 240A, 240B. As illustrated, the knob 240A in FIG. 2 is displaying information and accepting input for a heated seat. To change the knob 240A to display an HVAC set point and allow it to be change, it may be depressed or touched in a predetermined manner. The knob 240B may be changed in the same way.

As described above, settings are input via the knobs 100A, 100B using the respective rings 110A, 110B. In an exemplary embodiment, the rings 110A, 110B each provide a haptic feedback. Such feedback may be provided by detents placed around the inside of the rings 110A, 110B. Thus, as the rings 110A, 110B are turned, a series of clicks are felt, each click representing an increase (for clockwise turning) or a decrease (for counterclockwise turning) of one point, e.g., one degree, one level of seat warming, etc.

In an exemplary embodiment, the haptic feedback depends upon the data displayed in the displays 120A, 120B. If a display pertains to a heated seat, then the number of detents may be 3, 4, 5 or 6. If a display pertains to an HVAC set point, then the number of detents may be much greater than 3-6, e.g., there may be 30-50 detents because of the larger number of inputtable points. Thus, in an exemplary embodiment, as the knobs 100A, 100B are selected to change the data they display and the features they control, the knobs 100A, 100B change the number of detents in their rings 110A, 110B depending on whether rougher control is desirable (in the case of heated seats: off, low, medium, high, etc.) or finer control is desirable (in the case of HVAC temperature control: 60° F. to 90° F.). Thus, as the data and control of the knobs 100A, 100B change, the haptics afforded by the knobs 100A, 100B change. Such change may be effected by a clutch and actuator. At the same time, the display of the segments 130A, 130B correspondingly changes. Finer control results in more segments 130A, 130B being displayed. Coarser control results in fewer segments 130A, 130B being displayed.

The change in the knobs 100A, 100B by touch may further be based upon a capacitive coupling with the driver and/or front-seat passenger in the automobile 200, in accordance with an exemplary embodiment of the present invention. The automobile 200 may further comprise low-voltage wires in the driver and front-seat passenger seats of the automobile 200. When touched by the driver or passenger, the knobs 100A, 100B are able to determine who has touched the knob by detecting a voltage in the knob resulting from the driver or passenger completing a circuit with the low-voltage wires. Such touch detection may be used to change the knobs 100A, 100B to provide functionality specific to the person who has touched such knob, such as to display information regarding the heat seat of such person and provide for control thereof, to display HVAC information regarding the HVAC zone of such person and provide for control thereof, etc. In an exemplary embodiment, the automobile 200 may include only one knob 100A or 100B. Capacitive coupling may be used to switch the knob to driver control/feature display or to passenger control/feature display.

The capacitive coupling discussed above is a means for sensing interaction with the knobs 100A, 100B. Other means for sensing interaction with the knobs 100A, 100B are contemplated. For example, each knob 100A, 100B may comprise an IR sensor or a camera for non-contact gesture sensing. Each knob 100A, 100B may also comprise an integrated microphone for voice-based user identification, proximity sensing, and/or touch sensing. Each knob 100A, 100B may also comprise a fingerprint sensor for user identification. All of such means may be used to change the functionality of the relevant knob 100A, 100B, or may be used as an alternative to the ring 110A, 110B to operate or adjust the selected functionality of the relevant knob 100A, 100B. The knobs 100A, 100B may also display user specific data from the cloud using the means for sensing interaction discussed herein. Capacitive coupling, and various means for sensing interaction with the knobs 100A, 100B are are illustrated in FIGS. 4-8.

In embodiments in which two knobs are used, as in the automobile 200, each knob 100A, 100B may include a camera. The combination of two cameras in the automobile 200 allows for a processor in the automobile 200 to create a 3D image of the interior of the automobile 200. Such image may allow the processor to determine which of the knobs 240A, 240B is being manipulated. In another exemplary embodiment, each knob 100A, 100B may include a microphone for direction finding and adaptive noise cancellation.

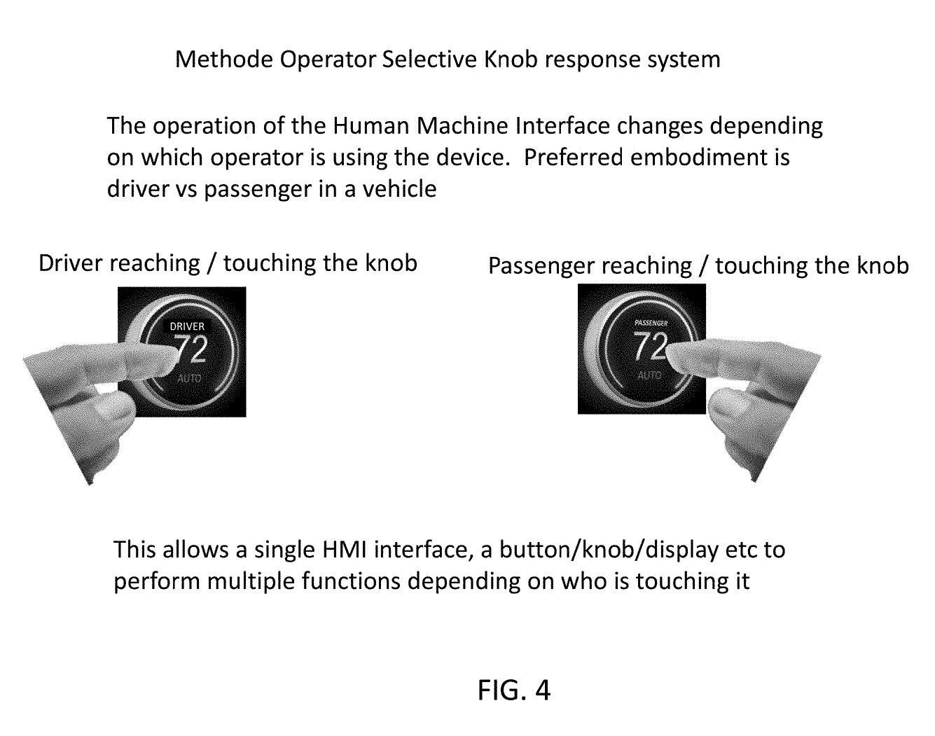

Referring now to FIGS. 3A and 3B are various other displays that may be displayed in the displays 110A, 110B of the knobs 100A, 100B. FIG. 3A illustrates PRNDL information. FIG. 3B illustrates warning information about other vehicles in the blind spot of the driver of the automobile 200.

Various benefits may be provided by the knobs 100A, 100B include:
Multifunction switch, by which it is easy to get to functions with display assist
Takes up less space on the instrument panel because fewer buttons and knobs are required
Larger temperature display, which is easier to read
Beautiful HMI
Provide quick boot information to driver, e.g., exterior temperature, current settings, weather
Able to control multiple functions in an integrated HMI control, e.g., rear seat audio/HVAC, seats
Lower cost HMI through replacing centerstack display
Less Distracting/easier to identify information quickly in automotive HMI\

Various other features include:
Changing the text/graphic size in the display 120A, 120B to indicate intention/control.
The knobs 100A, 100B may further include backlights, the colors of which change depending on the features controlled by the knobs 100A, 100B.
The knobs 100A, 100B may further include halo lighting, the colors of which change depending on the features controlled by the knobs 100A, 100B.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A rotary control knob disposed in an automobile, the rotary control knob comprising:
a central portion comprising a display; and
a radial encoder disposed around the central portion,
wherein the display selectively displays at least first information regarding a first function of the automobile and second information regarding a second function of the automobile; and
wherein the radial encoder selectively receives input regarding the first function of the automobile when the first information is displayed on the display and receives input regarding the second function of the automobile when the second information is displayed on the display.

2. The rotary control knob of claim 1, further comprising backlights or halo lighting of various color, wherein the color presented is pre-determined to coincide with information displayed on the display, whereby the rotary control knob provides ease in function selection by providing display and color assist.

3. The rotary control knob of claim 1, wherein the radial encoder selectively receives input regarding the first function only when the first information is displayed in a primary area of the display, while the second information is displayed in a secondary area of the display, and the radial encoder selectively receives input regarding the second function only when the second information is displayed in the primary area of the display, while the first information is displayed in a secondary area of the display.

4. The rotary control knob of claim 3, wherein the display further displays first indicia regarding a first range of inputs permissible for the first function of the automobile and second indicia regarding a second range of inputs permissible for the second function of the automobile, where the first range of inputs differs from the second range of inputs, and where the display displays the first indicia when the first information is displayed in a primary area and the display displays the second indicia when the second information is displayed in a primary area.

5. The rotary control knob of claim 4, wherein the first indicia comprises a first number of segments, and the second indicia comprises a second number of segments, each segment providing haptic feedback.

6. The rotary control knob of claim 3, wherein selection between the first function and the second function of the automobile is performed by one of the group consisting of a touch-sensitive feature of the display, joystick movement of the knob, voice recognition, gesture recognition, and biometric recognition.

7. The rotary control knob of claim 6, wherein functions having information displayed in the primary area of the display and the secondary area of the display are selected from the group consisting of HVAC temperature setpoint, heated seat operation, and fan control.

8. The rotary control knob of claim 3, wherein, in addition to the radial encoder selectively receiving input regarding selected function displayed in the primary area, selectively receiving input can be by operation of one of the group consisting of a touch-sensitive feature of the display, joystick movement of the knob, voice recognition, gesture recognition, and biometric recognition.

9. A rotary control knob disposed in an automobile, the rotary control knob comprising:
a central portion comprising a display; and
a radial encoder disposed around the central portion,
wherein the display selectively displays at least first information regarding a first function of the automobile and second information regarding a second function of the automobile; and
wherein the radial encoder selectively receives input regarding the first function of the automobile and the second function of the automobile.

10. The rotary control knob of claim 9, wherein the radial encoder selectively receives input regarding the first function of the automobile only when the first information is displayed on a primary area of the display, and receives input regarding the second function of the automobile only when the second information is displayed on the primary area of the display.

11. The rotary control knob of claim 9, wherein selection between the first function and the second function of the automobile is by capacitive coupling, wherein wiring transmitting pre-determined voltage to each of a driver seat and a front passenger seat of the automobile provide seat identifying capability, by voltage recognition, upon user contact with a respective seat and touch of the rotary control.

12. The rotary control knob of claim 11, wherein the first function is driver zone features and the second function is front passenger zone features.

13. The rotary control knob of claim 11, wherein, upon driver seat identification by capacitive coupling, only functions specific to the driver seat are provided for selection, and upon front passenger seat identification by capacitive coupling, only functions specific to the front passenger seat are provided for selection.

14. The rotary control knob of claim 11, wherein the first function is driver HVAC zone temperature and driver seat heat indication and the second function is front passenger HVAC zone temperature and front passenger seat heat indication, where, upon driver seat identification by capacitive coupling, the first function is selected and upon front passenger seat identification by capacitive coupling, the second function is selected.

15. The rotary control knob of claim 14, wherein the first information displayed is driver HVAC zone temperature setting and driver seat heat indication (on/off) and setting, and the second information displayed is front passenger HVAC zone temperature setting and front passenger seat heat indication (on/off) and setting.

16. The rotary control knob of claim 15, wherein selection between the first function and the second function of the automobile is by non-contact gesture sensing by the rotary control by sensor or camera, wherein gesture sensing in a vicinity of a driver seat provide functions specific to the driver for selection, and gesture sensing in a vicinity of a front passenger provide functions specific to the front passenger for selection.

17. The rotary control knob of claim 16, wherein the first function is driver HVAC zone temperature and driver seat heat control and the second function is front passenger HVAC zone temperature and front passenger heat control, where, upon gesture sensing in a vicinity of a driver seat, the first function is selected and upon gesture sensing in a vicinity of a front passenger, the second function is selected.

18. A rotary control knob disposed in an automobile, the rotary control knob comprising:
a central portion comprising a display; and
a radial encoder disposed around the central portion,
wherein the display selectively displays at least first information regarding a first function of the automobile and second information regarding a second function of the automobile;
wherein the radial encoder selectively receives input regarding the first function only when the first information is displayed in a primary area of the display, while the second information is displayed in a secondary area of the display, and the radial encoder selectively receives input regarding the second function only when the second information is displayed in the primary area of the display, while the first information is displayed in a secondary area of the display; and
wherein function selection of the automobile is by capacitive coupling; where wiring transmitting pre-determined voltage to each of a driver seat and a front passenger seat of the automobile provide seat identifying capability, by voltage recognition, upon user contact with a respective seat and touch of the rotary control; where, upon driver seat identification by capacitive coupling, the first and the second functions are specific to the driver seat, and upon front passenger seat identification by capacitive coupling, the first and the second functions are specific to the front passenger seat.

19. The rotary control knob of claim 18, where, upon driver seat identification by capacitive coupling, the first function is driver HVAC zone temperature and the second function is driver seat heat indication; and, upon front passenger seat identification by capacitive coupling, the first function is front passenger HVAC zone temperature and the second function is front passenger seat heat indication.
